(19) United States
(12) Patent Application Publication
(10) Pub. No.: US 2016/0219857 A1
(43) Pub. Date: Aug. 4, 2016

(54) HORSESHOE WITH METAL CLIPS

(71) Applicant: David FISHMAN, Rishon Le'Zion (IL)

(72) Inventor: David FISHMAN, Rishon Le'Zion (IL)

(21) Appl. No.: 14/608,310

(22) Filed: Jan. 29, 2015

(51) Int. Cl. A01L 1/04; B21K 15/02

(52) U.S. Cl. CPC A01L 1/04; B21K 15/02

(57) ABSTRACT

A horseshoe includes a blank that is shapeable to substantially conform to a contour of a hoof. The blank includes a plurality of webs each having a thickness that is thinner than a thickness of an adjacent region of the blank. Metal clips are each shaped to attach to one of the webs such that opposite plates of each clip sandwiches at least a portion of the web. Each of the opposite plates includes a hole. Each web is adaptable to enable the attachment of a clip such that when the horseshoe is aligned to the hoof, the nail holes on the opposite plates are substantially aligned with one another and with a white line of the hoof to enable driving of a nail through the holes and into the hoof at the white line.

### FIELD OF THE INVENTION

The present invention relates to horseshoes. More particularly, the present invention relates to a horseshoe with metal clips.

### BACKGROUND OF THE INVENTION

A horse is born with hooves that are adapted to walking in its natural habitat. In nature, a horse may walk several types of ground surfaces and cover 30 km to 40 km a day. In this setting, the hoof is well adapted to the horse's needs, and such natural activity generally results in a hardened hoof.

A horse's hoof includes an outer cornified capsule that encapsulates an inner part that includes nerves, blood vessels, and bone. The hoof has sufficient flexibility to adapt to the ground surface. The hoof widens when contacting the ground, and its shape is adaptable to rocky or uneven ground. The lower central part of the hoof includes a softer region, or frog, that is connected to the horse's circulatory system. Pressure on the frog assists in pumping blood from the hoof toward the heart.

When horses were domesticated, the conditions of domestication diverged from these natural conditions. Human masters provided nourishment such that there was no longer a need for horses to roam about to find food. As a result, the hoof began to grow at a rate that was no longer balanced by daily wear. Also, as a result of the reduction in daily activity, the hoof of the domestic horse is softer and less protective of internal structure than that of the wild horse.

Since antiquity, horses have been utilized for work and warfare. Thus, at times, the horse was expected to perform strenuous tasks for a limited period of time. The hoof of the domestic horse could not withstand this stress. As a result, the metal horseshoe, nailed to the horse's hoof, was developed. Metal horseshoes were already known in Roman times, and the horseshoe substantially in its present form is at least 1000 years old. The horseshoe provided a solution to accommodate both the relatively sedentary daily life of the horse, and the occasional extreme demands of the horse. More recently, plastic horseshoes have been developed for veterinary purposes and for a limited number of other special uses. Plastic horseshoes may provide a degree of flexibility and cushioning.

### SUMMARY OF THE INVENTION

There is thus provided, in accordance with an embodiment of the present invention, a horseshoe including: a blank that is shapeable to substantially conform to a contour of a hoof, the blank including a plurality of webs each having a thickness that is thinner than a thickness of an adjacent region of the blank; and a plurality of metal clips, each of the metal clips being shaped to attach to a web of the plurality of webs such that opposite plates of each of the clips sandwich at least a portion of the web to which that clip is attached, each of the opposite plates including a hole, each web being adaptable to enable the attachment of a clip of the plurality of metal clips such that when the horseshoe is aligned to the hoof, the holes on the opposite plates are substantially aligned with one another and with a white line of the hoof to enable driving of a nail through the holes and into the hoof at the white line.

Furthermore, in accordance with an embodiment of the present invention, the blank includes a substantially radial slit.

Furthermore, in accordance with an embodiment of the present invention, the blank is sufficiently transparent to enable discerning an indication of the white line via the blank when the blank is held against a bottom of the hoof.

Furthermore, in accordance with an embodiment of the present invention, each web is adaptable by trimming a distal end of that web or by placement of a slot that is cut on that web.

Furthermore, in accordance with an embodiment of the present invention, the blank includes plastic.

Furthermore, in accordance with an embodiment of the present invention, the opposite plates of the clip are each provided with a post that is configured to be inserted through a slot in a web of the plurality of webs.

Furthermore, in accordance with an embodiment of the present invention, an end of the clip is configured to be inserted through a slot in a web of the plurality of webs.

Furthermore, in accordance with an embodiment of the present invention, the end includes a tab that is insertable through a slot on a bendable plate of the clip, the tab being configured to spread laterally or bend to hold the tab in the slot.

Furthermore, in accordance with an embodiment of the present invention, the clip includes a projection such that, when the horseshoe is placed on a hoof, the projection extends upward outside of the hoof.

Furthermore, in accordance with an embodiment of the present invention, the clip includes a projection such that, when the horseshoe is placed on a hoof, the projection extends downward.

Furthermore, in accordance with an embodiment of the present invention, the projection includes a spike.

Furthermore, in accordance with an embodiment of the present invention, the horseshoe includes a metal clip without a hole for a nail.

There is further provided, in accordance with an embodiment of the present invention, a method of preparing a horseshoe for attachment to a hoof, the method including: preparing for attachment of a plurality of metal clips a blank that is shaped to cover a bottom of the hoof, the blank including a plurality of webs, each web for attachment of a metal clip of the plurality of metal clips being adapted such that when that clip is attached to that web and the blank is aligned with the hoof, a nail hole of the clip is substantially aligned with a white line of the hoof; and attaching each clip of the plurality of metal clips to a web of the plurality of webs.

Furthermore, in accordance with an embodiment of the present invention, preparing the blank includes marking an outer contour of the hoof on the blank when the blank is held to the hoof, and cutting the blank substantially along the marked outer contour.

Furthermore, in accordance with an embodiment of the present invention, preparing the blank includes marking a position of the white line of the hoof on the blank when the blank is held to the hoof, and trimming each web of the plurality of webs in accordance with the marked position.

Furthermore, in accordance with an embodiment of the present invention, preparing the blank includes marking a position of the white line of the hoof on the blank when the blank is held to the hoof, and cutting a slot into each web of the plurality of webs in accordance with the marked position.

Furthermore, in accordance with an embodiment of the present invention, attaching each clip includes insertion of two substantially parallel end plates of the clip through a corresponding two slots in a web of said plurality of webs, and bending one of end plates.

Furthermore, in accordance with an embodiment of the present invention, attaching each clip includes insertion of an end plate of that clip through a slot in a web of the plurality of webs and closing a bendable plate such that a tab on the end plate is inserted through a slot in the bendable plate.

Furthermore, in accordance with an embodiment of the present invention, the method includes attaching each clip, which includes applying a tool to laterally spread the tab or bending the tab to hold the tab in the slot.

Furthermore, in accordance with an embodiment of the present invention, the method includes attaching a metal clip without a nail hole to an additional web of the blank.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIG. 1 schematically illustrates a plastic and metal horseshoe, in accordance with an embodiment of the present invention.

FIG. 2A schematically illustrates a face of a plastic horseshoe blank for the horseshoe shown in FIG. 1.

FIG. 2B schematically illustrates a side view of the plastic horseshoe blank shown in FIG. 2A.

FIG. 3A is a schematic perspective view of fitting the plastic horseshoe blank of FIG. 2A to a hoof.

FIG. 3B is a schematically illustrates marking the plastic horseshoe blank of FIG. 2A to indicate structure of the hoof relative to the blank.

FIG. 4 schematically illustrates the plastic horseshoe blank of FIG. 3B after shaping.

FIG. 5 schematically illustrates the plastic horseshoe blank of FIG. 4 prepared for attachment of metal clips.

FIG. 6A schematically illustrates attachment of a metal clip to the plastic horseshoe blank of FIG. 5.

FIG. 6B is a schematic sectional view of preparing the metal clip shown in FIG. 6A for attachment to the plastic horseshoe blank.

FIG. 6C is a schematic side view of the metal clip in FIG. 6B while open and in place on the plastic horseshoe blank.

FIG. 6D is a schematic side view of the metal clip of FIG. 6C after closing.

FIG. 7A is a schematic illustration of a metal clip for locking into by use of a tool, in accordance with an embodiment of the present invention.

FIG. 7B shows a variation of the metal clip of FIG. 7A, with an upward projection.

FIG. 7C shows a variation of the metal clip of FIG. 7A, with a downward projection.

FIG. 7D shows a variation of the metal clip of FIG. 7C, with a downward-projecting spike.

FIG. 8 shows a slit horseshoe blank, in accordance with an embodiment of the present invention.

FIG. 9A schematically illustrates a metal clip for insertion through two slots in a horseshoe blank, in accordance with an embodiment of the present invention.

FIG. 9B schematically shows a horseshoe blank that is adapted for attachment of the metal clip shown in FIG. 9A.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, us of the conjunction “or” as used herein is to be understood as inclusive (any or all of the stated options).

In accordance with an embodiment of the present invention, a horseshoe includes a horseshoe blank that may be shaped to be fitted to a hoof of a horse or other animal A plurality of metal clips may be firmly attached to the horseshoe blank. For example, the horseshoe may be made of plastic or another lightweight material (e.g., wood, cardboard, or another suitable material). The material used for the horseshoe blank may be lighter, more flexible, and more transparent than a similarly sized and shaped metal object. The material used for the horseshoe blank may be cut or shaped using tools typically design for work on plastic or wood, without need for tools designed especially for working with plastic.

When the clips are attached, at least a portion of the horseshoe blank is sandwiched between opposite plates of the metal clip (e.g., upper and lower plates when the horseshoe is attached to a hoof of an animal that is standing erect). The metal clips include a pair of aligned nail holes on the upper and lower plates of the metal clip. The metal clips may be attached to the horseshoe blank such that when the resulting horseshoe is placed on the hoof, the nail holes are aligned with the white line of the hoof. As used herein, a nail hole is aligned with the white line when the nail hole is positioned at a point relative to the white line where the farrier or other person shoeing the hoof intends to drive a nail. The point is typically on the white line or near (e.g., within 5 mm, or in some cases within 2 mm of) the white line. Nails may be driven via nail holes through the plates and the sandwiched portion of the horseshoe blank into the hoof at the white line. As used herein, a position at the white line or water line refers to a position on or near (e.g., within 2 mm of) the white line or water line of the hoof. Other clips that are attached to the horseshoe blank may serve purposes other than attachment of the horseshoe to the hoof. Such other clips may not include nail holes.

A horseshoe in accordance with an embodiment of the present invention may provide solutions to problems with both metal and plastic horseshoes.

Traditional metal (typically iron or steel) horseshoes provide good protection to the hoof against injury and wear. However, the rigidity of the metal horseshoe prevents the hoof in adjusting its shape in accordance with the hoof's natural flexibility. Thus, a metal horseshoe may prevent the hoof from properly adapting to different ground surface conditions. The rigidity may also transfer the shock of contact with the ground to the horse's leg and body. Since a metal horseshoe typically raises the frog of the hoof, and since the rigidity of the metal horseshoe prevents the horseshoe from bending or deforming upon contact with the ground, the frog may be prevented from contacting the ground. When the frog is prevented from contacting the ground, proper operation of the horse's circulatory system may be interfered with.

A plastic horseshoe, by being more flexible than a metal horseshoe, could, in principle, solve these problems. However, a typical plastic horseshoe is not sufficiently strong to be held in place by a nail. Thus, typically, a plastic horseshoe is glued to the hoof. Such gluing may be suitable only for short-term situations, or where the horse is not expected to be active. Alternatively, a plastic horseshoe may be configured to fit over the hoof. Since plastic may not be bent in the same manner as metal, fitting a plastic horseshoe may involve custom production (e.g., molding) to size and special shoeing techniques. Such custom production of a plastic horseshoe may be very expensive. The alternative, stocking a large number of different sizes of plastic horseshoes, may be impractical for a farrier.

A horseshoe blank in accordance with an embodiment of the present invention, may provide the flexibility of a plastic horseshoe, and enable the hoof to react more naturally to ground conditions an impact with the ground than would a metal horseshoe. On the other hand, the metal clips with nail holes enable attachment to the hoof with nails. Some or all of the clips may be configured to provide (increased resistance to wear over a plastic horseshoe.

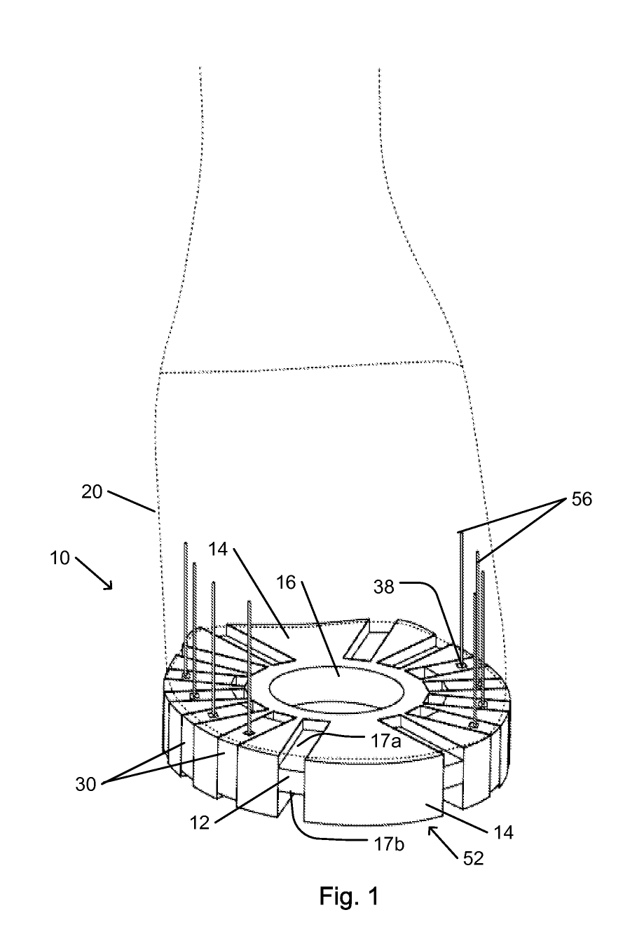

FIG. 1 schematically illustrates a plastic and metal horseshoe, in accordance with an embodiment of the present invention.

Horseshoe 10 is configured to fit on hoof 20. Horseshoe 10 includes an adapted horseshoe blank 52 made of a plastic. A plurality of metal clips 30 are attached to clip attachment webs 12 of adapted horseshoe blank 52. Some or all of metal clips 30 may include nail holes 38. Nails 56 may be driven through nail holes 38 to attach horseshoe 10 to (e.g., at a white line or water line of) hoof 20. Typically, when a metal clip 30 is attached to adapted horseshoe blank 52, an upward-facing (e.g., configured to face the bottom of hoof 20) surface of the metal clip 30 is substantially flush with an upward-facing surface of adapted horseshoe blank 52. A downward-facing (e.g., configured to contact the surface on which hoof 20 and horseshoe 10 are resting) surface of metal clip 30 may be recessed (e.g., by a few millimeters, typically less than 1 centimeter) from a downward-facing surface of adapted horseshoe blank 52. A central hole 16 of horseshoe 10 may reduce the weight and increase flexibility of horseshoe 10.

Horseshoe 10 may be prepared from a horseshoe blank that is modified to fit a particular hoof and to which metal clips 30 are attached.

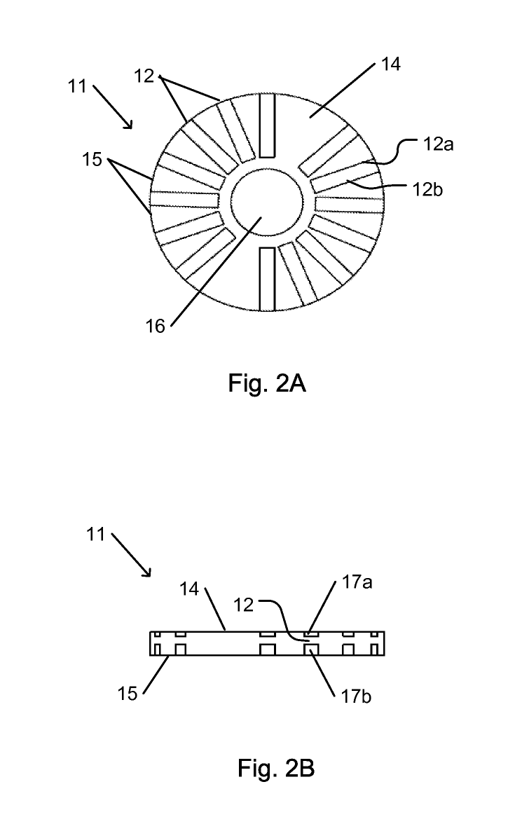

FIGS. 2A-6D present stages in preparing a horseshoe 10 for attachment to a hoof.

FIG. 2A schematically illustrates a face of a horseshoe blank for the horseshoe shown in FIG. 1. FIG. 2B schematically illustrates a side view of the horseshoe blank shown in FIG. 2A.

Horseshoe blank 11 may be initially in the form of a disk, as shown. The diameter of horseshoe blank 11 may be sufficiently large to cover a large variety of hoof sizes. For example, horseshoe blank 11 may have a diameter of about 160 mm, or another suitable size. Several different sizes of horseshoe blank 11 may be designed for different horse breeds, groups of horse breeds, or other animals that may benefit from shoeing. Alternatively or in addition, a horseshoe blank may be initially in another form that is at least as large as the hoof to which the horseshoe blank is to be fitted.

Horseshoe blank 11 may be constructed of a plastic. For example, the plastic may include polyurethane, a polyurethane compound, reinforced polyurethane, rubber, or another plastic that provides the required or desired flexibility, durability, or other property. The material of which horseshoe blank 11 is constructed may be transparent, semitransparent (e.g., colored or tinted), or translucent. The transparency or translucency of horseshoe blank 11 may be such as to enable at least blurred viewing of structure of a hoof, or an indication of structure of the hoof (such as the outer contour, the frog, and the white line) through horseshoe blank 11 when horseshoe blank 11 is placed on the hoof for fitting. Typically, an indication of the white line may include coloring or darkening, e.g., with a dark marker, or with a color or substance that is readily discerned. Thus, the position of the white line may be discerned via horseshoe blank 11 during fitting.

Horseshoe blank 11 includes a plurality of thin webs in the form of clip attachment webs 12. The thickness of each clip attachment web 12 is thinner than that of an adjacent separation section 15 or web-less region 14, or of other adjacent region, section, or structure of horseshoe blank 11. Lateral sides 12a and 12b of each web structure may be substantially parallel. Each clip attachment web 12 extends to the outer perimeter of horseshoe blank 11.

Each clip attachment web 12 may be adapted by a farrier to enable attachment of a metal clip 30 (FIG. 1). Each clip attachment web 12 is formed between an upper web groove 17a and a lower web groove 17b. Typically, upper web groove 17a may be similar or substantially equal to lower web groove 17b. Each clip attachment web 12 may be oriented in a general radial direction. In some cases, some or all of the web structures may be oriented at an oblique angle to the radial direction.

Horseshoe blank 11 may include one or more web-less regions 14. For example, a web-less region 14 may be configured for placement on a part of the hoof, (e.g., front or back part) to which a horseshoe 10 (FIG. 1) need not, or should not, be attached with nails.

Horseshoe blank 11 may include a central hole 16. For example, central hole 16 may be configured for placement over a frog of the hoof.

In order to form a horseshoe 10 that incorporates horseshoe blank 11, horseshoe blank 11 may be adapted to a particular hoof. For example, a father cut horseshoe blank 11 to match a contour of the hoof. Prior to cutting, horseshoe blank 11 be fitted to the hoof. For example, horseshoe blank 11 may be marked to indicate an outline of the outer perimeter of the hoof, and a position of the white line of the hoof (along which nails to hold horseshoe 10 to the hoof are typically driven), relative to horseshoe blank 11 (e.g., after marking or coloring the white line to increase its visibility via horseshoe blank 11).

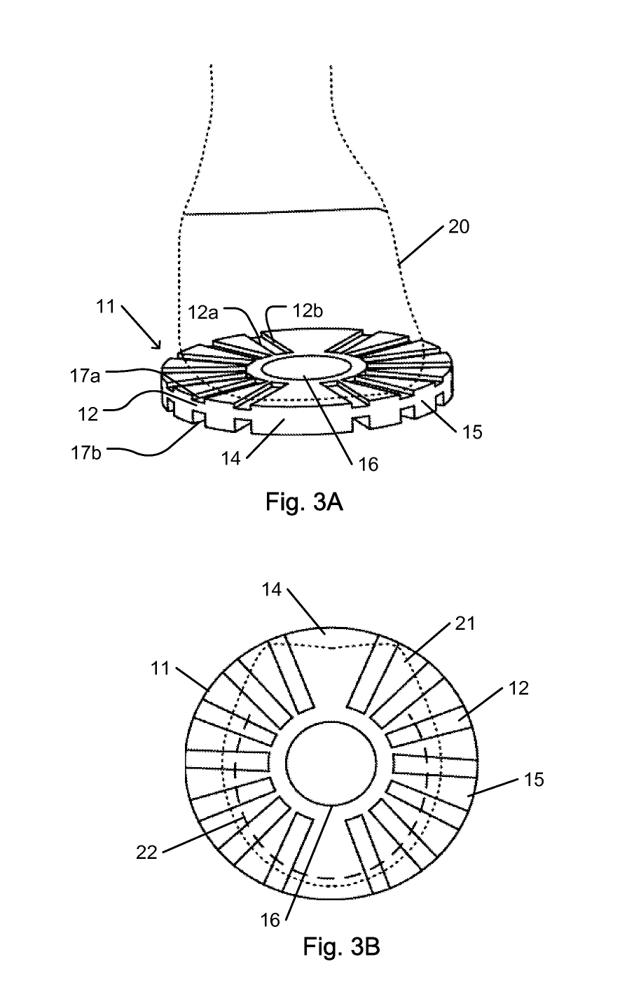

FIG. 3A is a schematic perspective view of fitting the horseshoe blank of FIG. 2A to a hoof.

A hoof 20 may be placed on a horseshoe blank 11 for fitting. During the fitting, horseshoe blank 11 may located and oriented relative to the hoof as would the final horseshoe. Thus, web-less regions 14 may be oriented along a frontward-backward direction relative to hoof 20. Hoof 20 may be placed on horseshoe blank 11 such that the frog of hoof 20 may be fully or partially placed over central opening 16 of horseshoe blank 11.

With hoof 20 placed on horseshoe blank 11, an outline of the outer perimeter of hoof 20 may be marked on horseshoe blank 11. For example, a marker, pencil, pen, crayon, or other writing, drawing, or marking instrument may be used to trace the outline of hoof 20 onto horseshoe blank 11.

FIG. 3B is a schematically illustrates marking the horseshoe blank of FIG. 2A to indicate structure of the hoof relative to the blank.

Hoof contour line 21 represents the outer contour of hoof 20 marked on horseshoe blank 11. With hoof 20 lifted, horseshoe blank 11 may be placed on hoof 20 such that hoof contour line 21 is aligned with the outer perimeter of hoof 20 as viewed via horseshoe blank 11. White line indication line 22 may be drawn to indicate an approximate position of the white line of hoof 20 relative to horseshoe blank 11.

Alternatively to physical marking of the contour, digital or computerized marking may be utilized. For example, images of hoof 20 may be acquired by one or more image acquisition devices (e.g., digital cameras) from one or more directions (e.g., from above the hoof and from below the hoof). One or more length references (e.g., a transparent ruled surface placed on or below the hoof when acquiring the images) may enable correct scaling of a digital representation of the hoof. An appropriately configured processor may then digitally superimpose one or more structures of hoof 20 (e.g., an outer contour and white line of hoof 20) on a digital rendering of horseshoe blank 11.

After horseshoe blank 11 is marked, horseshoe blank 11 may be cut to at least cover the bottom of hoof 20. For example, horseshoe blank 11 may be cut along, or outside (e.g., by a small distance, e.g., about 5 millimeters, or less than one or two centimeters, or by a longer distance, outside of) hoof contour line 21. For example, horseshoe blank 11 may be cut along or outside of hoof contour line 21 using a handheld saw (manual or mechanical), mechanical saw (e.g., jigsaw) or mill, or a computerized machining device (e.g., on the basis of a digital representation of horseshoe blank 11 and hoof contour line 21), or another suitable cutting or shaping device.

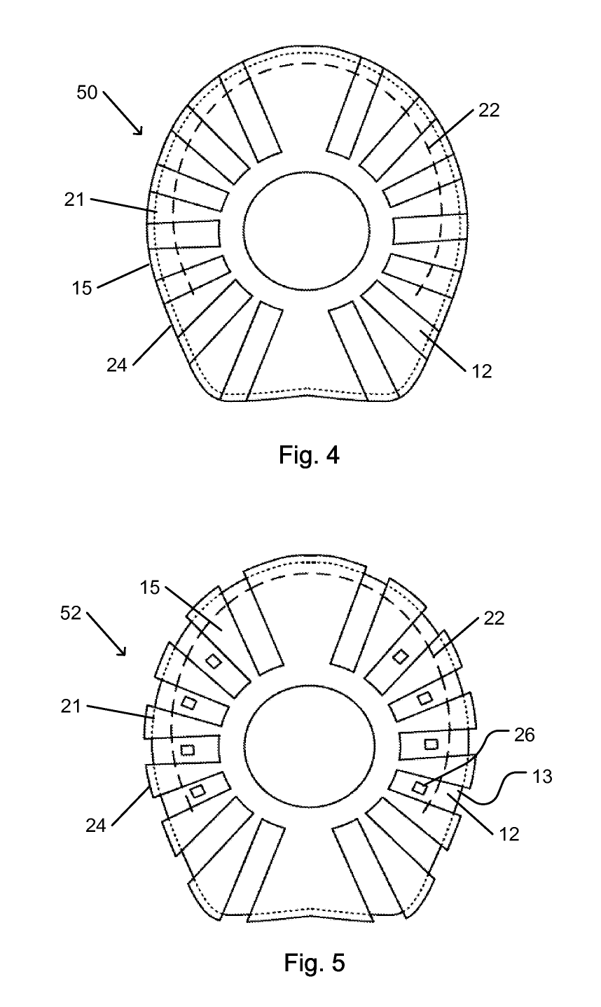

FIG. 4 schematically illustrates the horseshoe blank of FIG. 3B after shaping.

The outer boundary 24 of shaped horseshoe blank 50 lies outside of hoof contour line 21.

After shaping of shaped horseshoe blank 50, clip attachment webs 12 may be adapted for attachment of metal clips. Each clip attachment web 12 to which a metal clip is to be attached may be modified such that when the resulting horseshoe is placed on a hoof, nail holes in the metal clip are approximately aligned with the white line of the hoof.

The adaptation of shaped horseshoe blank 50 may include trimming a distal (to shaped horseshoe blank 50) end of each clip attachment web 12 to enable placement of the metal clip at the required point on that clip attachment web 12. A hole may be drilled or punched through clip attachment web 12 to accommodate one or more attachment posts of the metal clip.

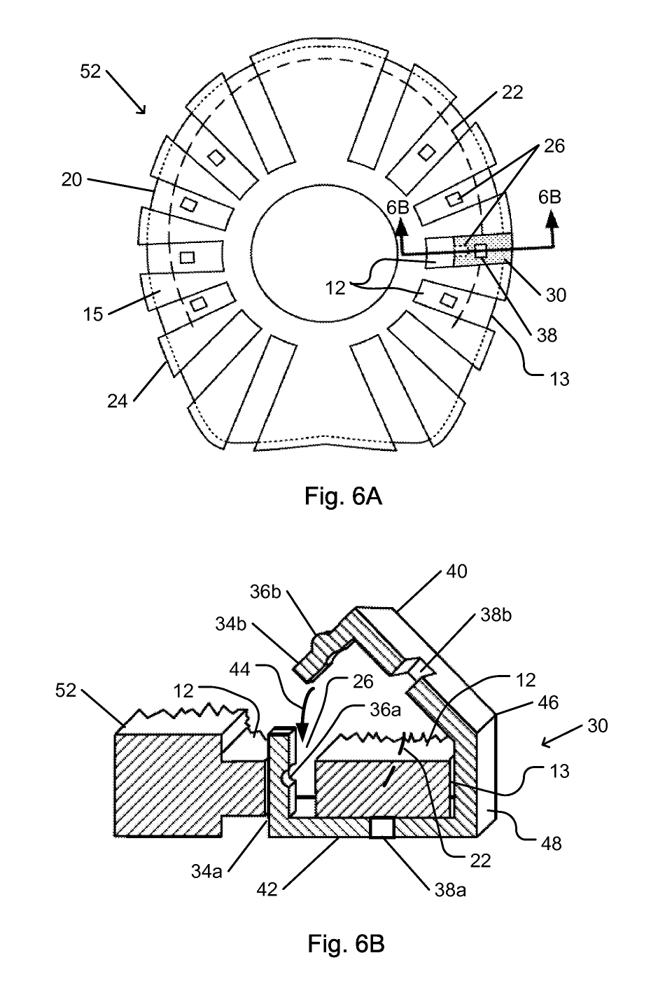

FIG. 5 schematically illustrates the horseshoe blank of FIG. 4 prepared for attachment of metal clips.

In adapted horseshoe blank 52, a trimmed distal end 13 of each clip attachment web 12 has been formed. The amount of trimming of trimmed distal end 13 is such to enable placement of a metal clip on clip attachment web 12 such that nail holes of the metal clip are substantially aligned with white line indication line 22. A post slot 26 has been cut (e.g., punched, drilled, machined, or otherwise cut) through each clip attachment web 12. The size and shape of post slot 26 is such as to enable passage of one or more attachment posts of the metal clip. For example, in some cases post slot 26 may extend across all or most of the width of clip attachment web 12.

Clip attachment webs 12 to which no metal clip is to be attached need not be trimmed and need not have a post hole formed.

For example, one or more tools may be provided to adapt a clip attachment web 12 for attachment of a metal clip. Such a tool may include a mark, viewing hole, or other positioning aid for placement at a point of the tool along white line indication line 22. The tool may include a knife for trimming web structure 13 at trimmed distal end 13, a punch for forming post slot 26, or both. Operating the tool when properly positioned relative to white line indication line 22 may trim clip attachment web 12 to form a properly positioned trimmed distal end 13, may form post slot 26, or both. For example, the tool may have a form similar to that of cutting pliers.

As another example, clip attachment web 12 may be manually marked at positions where trimmed distal end 13 and post slot 26 are to be formed. A stencil-like guide tool may be provided to assist in the marking. Standard cutting or trimming tools (e.g., cutting pliers, saw, mill, or other tool) and hole-forming tools (e.g., hole punch, drill, awl, or other tool) may then be applied to the marked positions to form trimmed distal end 13 and post slot 26. As another example, a digitally controlled shaping machine may automatically form trimmed distal end 13 and post slot 26, e.g., concurrent with, or separately from, shaping of shaped horseshoe blank 50 (FIG. 4). As another example, three-dimensional printing techniques may be applied to directly produce adapted horseshoe blank 52.

After preparation of adapted horseshoe blank 52, metal clips may be attached to clip attachment webs 12.

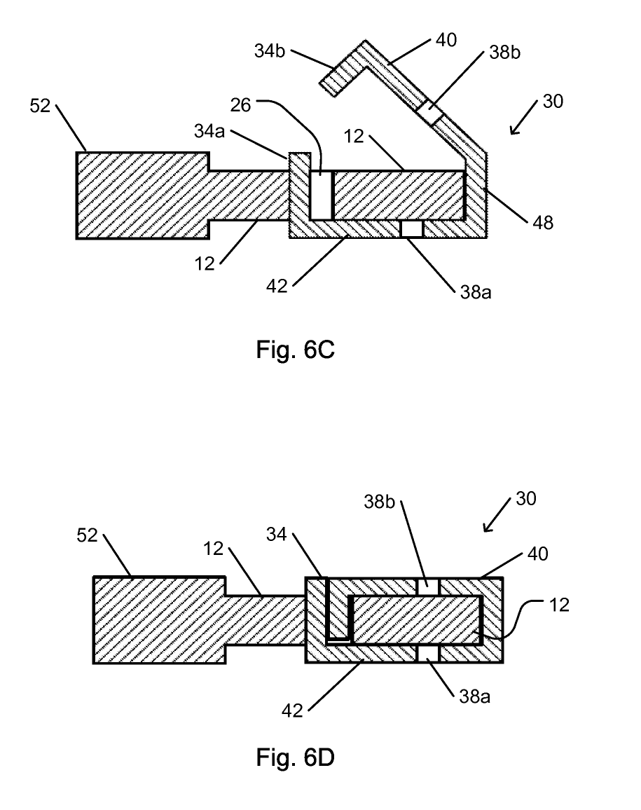

FIG. 6A schematically illustrates a metal clip attached to the horseshoe blank of FIG. 5.

Metal clips 30 may be attached to clip attachment webs 12 of adapted horseshoe blank 52. Attachment of metal clips 30 to adapted horseshoe blank 52 is such that nail holes 38 of metal clips 30 are approximately aligned with white line indication line 22.

FIG. 6B is a schematic sectional view of attachment of a metal clip shown in FIG. 6A for attachment to the horseshoe blank. FIG. 6C is a schematic side view of the metal clip in FIG. 6B while open and in place on the horseshoe blank.

Metal clip 30 includes a bendable plate 40 and a fixed plate 42 connected by end plate 48. Metal clip 30 may be made of iron, various types of steel (e.g., varying in hardness or elasticity), aluminum, copper or copper alloys, or another suitable metal. The thickness may be less than about one half of a centimeter, e.g., about 2 mm A shape and width of metal clip 30 may be such as to fit within a clip attachment web 12. The fit may be such that the lateral walls of clip attachment web 12 constrain or prevent lateral motion of metal clip 30 within clip attachment web 12.

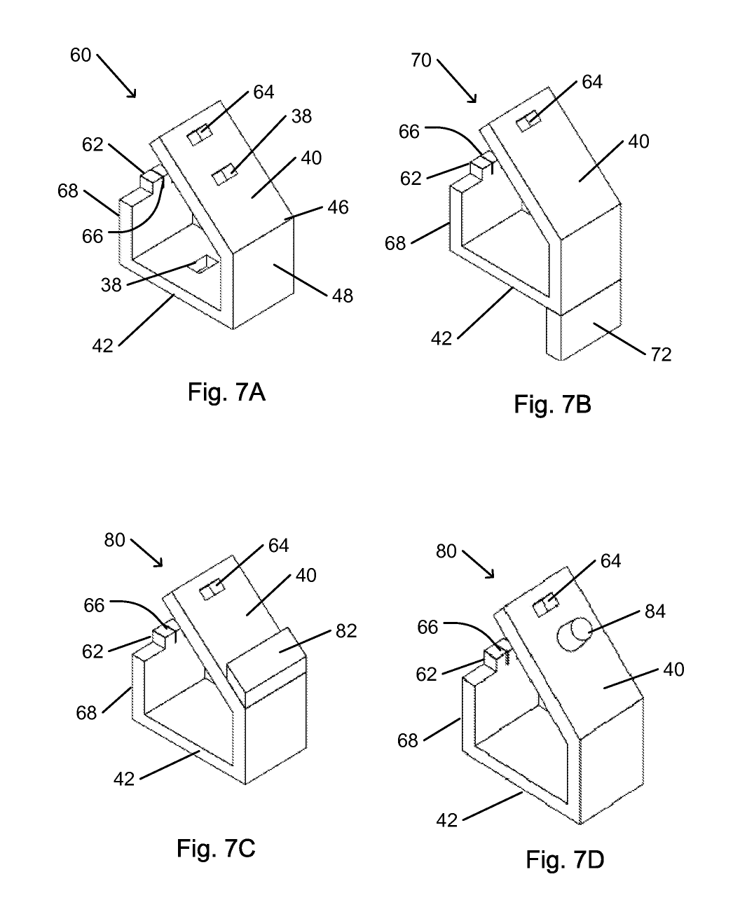

Typically, bendable plate 40 is attached to clip attachment web 12 so as to face downward when attached to a hoof. Thus, in this case, fixed plate 42 may be placed into upper web groove 17a (FIG. 1) and bendable plate 40 may be placed into lower web groove 17b. In some cases, the positions of bendable plate 40 and fixed plate 42 may be reversed. The thicknesses of bendable plate 40 and fixed plate 42 may be approximately the same, or one may be thicker than the other. For example, when fixed plate 42 is placed into upper web groove 17a, the thickness of fixed plate 42 may be approximately equal to the depth of upper web groove 17a. The thickness of bendable plate 40 may be less (e.g., by a few millimeters) than the depth of lower web groove 17b, approximately equal to the depth of lower web groove 17b, or in some cases, more (e.g., by a few millimeters) than the depth of lower web groove 17b (e.g., depending on a purpose of the metal clip, as described below in connection with FIGS. 7B-7D). Bendable plate 40 may be bendable relative to end plate 48 at connection 46.

A surface of metal clip 30 that is designed to face downward (e.g., of bendable plate 40) when the resulting horseshoe is attached to the hoof may be adapted to particular circumstances. For example, the surface may be roughened, spiked, provided with a layer of a material, or otherwise adapted to increase traction on one or more types of ground. One or more projections may extend upward to provide additional protection to sides of the hoof. The downward facing surface may have sufficient thickness so as to be flush with a downward facing surface of (e.g., of separation section 15 or web-less section 14 of) adapted horseshoe blank 52.

Initially, attachment post 34a of fixed plate 42 may be inserted through post slot 26 of clip attachment web 12. When so inserted, trimmed distal end 13 of clip attachment web 12 may abut end plate 48 of metal clip 30 and nail hole 38a of fixed plate 42 may be approximately aligned with white line indication line 22.

Bendable plate 40 may be bent about connection 46 to lower bendable plate onto clip attachment web 12. When so bent, attachment post 34b of bendable plate 40 may be inserted with insertion motion 44 into post slot 26. Bendable plate 40 may be sufficiently flexible to enable insertion of attachment post 34b into post slot 26.

Typically, attachment post 34b is inserted into a post slot 26 into which attachment post 34a has already been inserted. Thus, locking structure 36b on attachment post 34b may engage cooperating locking structure 36a on attachment post 34a. The engagement of locking structure 36b with cooperating locking structure 36a may prevent opening of metal clip 30. Alternatively or in addition, nailing of metal clip 30 to a hoof via nail holes 38a and 38b may hold metal clip 30 to the hoof, and prevent opening of metal clip 30.

FIG. 6D is a schematic side view of the metal clip of FIG. 6C after closing.

After closing metal clip 30, part of clip attachment web 12 is sandwiched between bendable plate 40 and fixed plate 42 of metal clip 30. Metal clip 30 is held to clip attachment web 12 by attachment posts 34a and 34b. After closing metal clip 30, nail hole 38b of bendable plate 40 may be aligned with nail hole 38a of fixed plate 42.

A sufficient number of metal clips 30 may attached to adapted horseshoe blank 52 to enable nailing of the resulting horseshoe 10 (FIG. 1) to a hoof 20. For example, the number of metal clips 30 to be attached may be determined (e.g., by a farrier or other person shoeing, or overseeing or assisting with shoeing) on the basis of the anticipated activity of the horse being shoed.

After attachment of metal clips 30, the resulting horseshoe 10 may be nailed to a hoof 20. For example, nails may be driven via aligned nail holes 38a and 38b into hoof 20 at the white line of hoof 20. After shoeing, an outer perimeter of adapted horseshoe blank 52 of horseshoe 10 may be filed, rasped, planed, or otherwise reshaped to closely match the outer contour of the hoof.

A metal clip of horseshoe 10 may be designed to be locked into place by separating adjacent posts with a tool.

FIG. 7A is a schematic illustration of a metal clip for locking into place by use of a tool, in accordance with an embodiment of the present invention.

End plate 68 of metal clip 60 is designed to be inserted through a post slot (e.g., spanning the width of) a clip attachment web of an adapted horseshoe blank. When bendable plate 40 is closed, tab 62, which includes tab slit 66, may be inserted through tab slot 64. After tab 62 has been inserted through tab slot 64, a wedge or other suitable tool may be applied to (e.g., inserted into and hammered or otherwise forced into) tab slit 66. The action of the tool may laterally spread tab 62 (e.g., laterally separate two adjacent parts of tab 62). The lateral spreading holds tab 62 in tab slot 64, and may thus lock bendable plate 40 to end plate 68 to prevent opening of metal clip 60. Alternatively or in addition, tab 62 may be bent (e.g., toward the center of the adapted horseshoe blank, or otherwise bent) in order to hold tab 62 in tab slot 64 and close metal clip 60.

Such locking may be durable even when no nail is nailed through nail holes 38. Thus, variations of metal clip 60 (such as are shown in FIGS. 7B-7C) may or may not include nail holes 38. Such variations may include various types of projections. The projections may be constructed of the same material as the remainder of the metal clip, or may be made of another metal or material (e.g., ceramic, plastic, or other material) with properties (e.g., hardness, rigidity or flexibility, elasticity, durability under various conditions, resistance to corrosion, coefficient of friction, or another property) that are suitable to a particular purpose (e.g., protection from bumping, increasing traction, protection from wear or breakage, or another purpose).

FIG. 7B shows a variation of the metal clip of FIG. 7A, with an upward projection.

When a horseshoe that incorporates metal clip 70 is attached to a hoof, upward projection 72 may extend upward outside of and around the outer perimeter of the hoof. Upward projection 72 may protect the hoof from side impacts. Upward projection 72 may serve to assist in holding in place on the hoof a horseshoe that incorporates metal clip 70.

FIG. 7C shows a variation of the metal clip of FIG. 7A, with a downward projection.

Downward projection 82 of metal clip 80 when incorporated into a horseshoe and attached to a hoof may be configured to provide one or more benefits. For example, downward projection 82 may be configured (e.g., by include a hard metal) to provide protection of the horseshoe against wear due to contact with the ground. A downward facing face of downward projection 82 may include structure (e.g., a roughened or otherwise prepared surface) or materials (e.g. a material with a high coefficient of friction for contact with the ground) that increase traction or provide additional protection against slipping.

FIG. 7D shows a variation of the metal clip of FIG. 7C, with a downward-projecting spike.

A downward projection in the form of spike 84 may be configured to engage the ground when metal clip 80 is incorporated into a horseshoe on a hoof, and may thus provide increased traction.

Variations of horseshoe blank 11 (FIG. 2A) may be configured to have various properties. For example, a variation of horseshoe blank 11 may be configured to have increased flexibility, thus enabling enhanced adaption of the horseshoe, and the hoof, to varying terrain. For example, a horseshoe blank may be provided with a slit that enables adaption to variations in a surface.

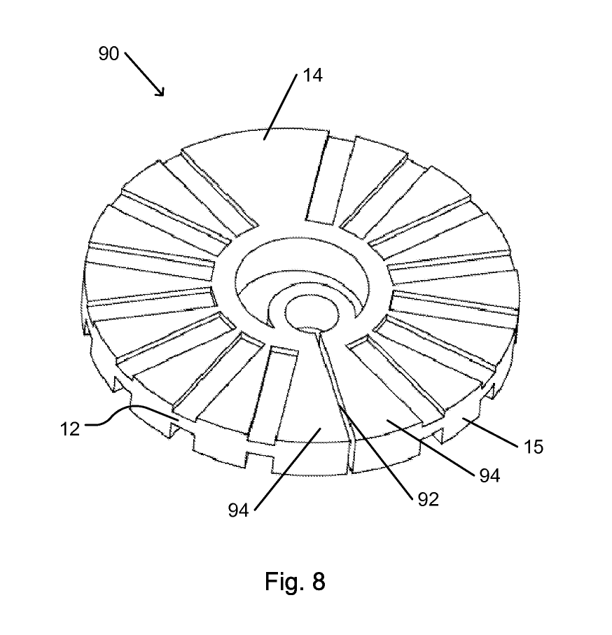

FIG. 8 shows a slit horseshoe blank, in accordance with an embodiment of the present invention.

Slit horseshoe blank 90 is provided with radial slit 92. Radial slit 92 may enable relative movement between adjacent sections 94. The relative movement may enable a horseshoe that incorporates slit horseshoe blank 90 to adapt to variations in local surface topography (e.g., when the hoof steps on a stone, object, or bump). The adaptation of the horseshoe to the variations in topography may enable, to at least a limited extent, the natural adaptation of the hoof to such variations.

In accordance with an embodiment of the present invention, a horseshoe blank may be adapted for attachment of a metal clip by forming two post slots in a clip attachment web of the blank. The metal clip may be initially shaped for insertion through the two post slots.

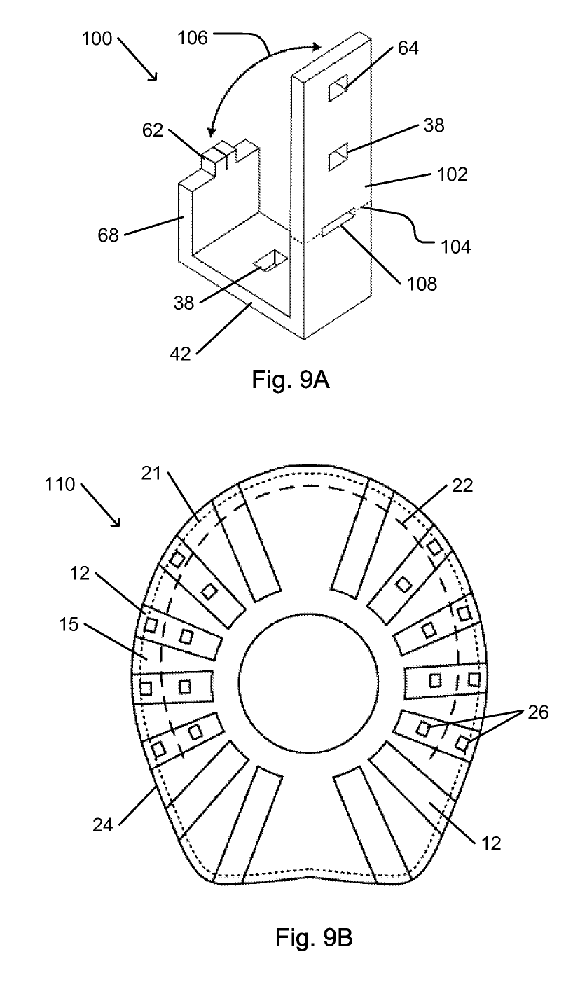

FIG. 9A schematically illustrates a metal clip for insertion through two slots in a horseshoe blank, in accordance with an embodiment of the present invention. FIG. 9B schematically shows a horseshoe blank that is adapted for attachment of the metal clip shown in FIG. 9A.

Metal clip 100 includes initially substantially parallel walls, end plate 68 and bendable end plate 102. Adapted horseshoe blank 110 includes two parallel post slots 26 on each clip attachment web 12 that has been adapted for attachment of a metal clip 100. The positions of post slots 26 on each adapted clip attachment web 12 correspond to those of end plate 68 and bendable end plate 102 or metal clip 100. The spacing between post slots 26 on each adapted clip attachment web 12 is substantially equal to the perpendicular distance between end plate 68 and bendable end plate 102 of metal clip 100. Thus, end plate 68 and bendable end plate 102 may be simply inserted through post slots 26.

The attachment may be completed by bending bendable end plate 102 substantially along bending line 104 with bending motion 106. Bending along bending line 104 may be facilitated by one or more slots 108 along bending line 104. Metal clip 100 may be closed by insertion of tab 62 through tab slot 64 and bending or otherwise securing tab 62 within tab slot 64.

The radial positions of post slots 28 on clip attachment web 12 are selected such that nail holes 38 are aligned with a white line indication line 22. Since a bendable end plate 102 is inserted through a post slot 28 in clip attachment web 12 (and not around a distal end of clip attachment web 12) there is no need to trim to size a distal end of clip attachment web 12.

For example, a tool for preparing a horseshoe blank for attachment of metal clip 100 may include a window or other arrangement to enable alignment of the tool with white line indication line 22. The tool may include a double punch or other component for formation of two post slots 28. The post slots 28 are formed with a spacing and position to enable concurrent insertion of end plate 68 and bendable end plate 102 and alignment of nail holes 38 with white line indication line 22.

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A horseshoe comprising:
a blank that is shapeable to substantially conform to a contour of a hoof, the blank comprising a plurality of webs each having a thickness that is thinner than a thickness of an adjacent region of the blank; and
a plurality of metal clips, each of the metal clips being shaped to attach to a web of said plurality of webs such that opposite plates of each of the clips sandwich at least a portion of the web to which that clip is attached, each of the opposite plates including a hole, each web being adaptable to enable the attachment of a clip of said plurality of metal clips such that, when the horseshoe is aligned to the hoof, the holes on the opposite plates are substantially aligned with one another and with a white line of the hoof to enable driving of a nail through the holes and into the hoof at the white line.

2. The horseshoe of claim 1, wherein the blank comprises a substantially radial slit.

3. The horseshoe of claim 1, wherein the blank is sufficiently transparent to enable discerning an indication of the white line via the blank when the blank is held against a bottom of the hoof.

4. The horseshoe of claim 1, wherein each web is adaptable by trimming a distal end of that web or by placement of a slot that is cut on that web.

5. The horseshoe of claim 1, wherein the blank includes a plastic.

6. The horseshoe of claim 1, wherein the opposite plates of the clip are each provided with a post that is configured to be inserted through a slot in a web of said plurality of webs.

7. The horseshoe of claim 1, wherein an end of the clip is configured to be inserted through a slot in a web of said plurality of webs.

8. The horseshoe of claim 7, wherein the end includes a tab that is insertable through a slot on a bendable plate of the clip, the tab being configured to spread laterally or bend to hold the tab in the slot.

9. The horseshoe of claim 1, wherein the clip comprises a projection such that, when the horseshoe is placed on a hoof, the projection extends upward outside of the hoof.

10. The horseshoe of claim 1, wherein the clip comprises a projection such that when the horseshoe is placed on a hoof, the projection extends downward.

11. The horseshoe of claim 10, wherein the projection comprises a spike.

12. The horseshoe of claim 1, further comprising a metal clip without a hole for a nail.

13. A method of preparing a horseshoe for attachment to a hoof, the method comprising:
preparing for attachment of a plurality of metal clips to a blank that is shaped to cover a bottom of the hoof, the blank comprising a plurality of webs, the preparing including adapting each web for attachment of a metal clip of said plurality of metal clips such that, when that clip is attached to that web and the blank is aligned with the hoof, a nail hole of the clip is substantially aligned with a white line of the hoof; and
attaching each clip of said plurality of metal clips to a web of said plurality of webs.

14. The method of claim 13, wherein preparing the blank comprises marking an outer contour of the hoof on the blank when the blank is held to the hoof, and cutting the blank substantially along the marked outer contour.

15. The method of claim 13, wherein preparing the blank comprises marking a position of the white line of the hoof on the blank when the blank is held to the hoof, and trimming each web of said plurality of webs in accordance with the marked position.

16. The method of claim 13, wherein preparing the blank comprises marking a position of the white line of the hoof on the blank when the blank is held to the hoof, and cutting a slot into each web of said plurality of webs in accordance with the marked position.

17. The method of claim 13, wherein attaching each clip comprises insertion of two substantially parallel end plates of the clip through a corresponding two slots in a web of said plurality of webs, and bending one of end plates.

18. The method of claim 13, wherein attaching each clip comprises insertion of an end plate of that clip through a slot in a web of said plurality of webs and closing a bendable plate such that a tab on the end plate is inserted through a slot in the bendable plate.

19. The method of claim 18, wherein attaching each clip comprises applying a tool to laterally spread the tab or bending the tab to hold the tab in the slot.

20. The method of claim 13, further comprising attaching a metal clip without a nail hole to an additional web of the blank.
